(19) United States
(12) Patent Application Publication
(10) Pub. No.: US 2011/0115735 A1
(43) Pub. Date: May 19, 2011

(54) Tablet Computers Having An Internal Antenna

(76) Inventors: Jeffrey A. Lev, Tomball, TX (US); Paul J. Doczy, Cypress, TX (US); Mark S. Tracy, Tomball, TX (US)

(21) Appl. No.: 13/003,007

(22) PCT Filed: Jul. 7, 2008
(86) PCT No.: PCT/US08/69298

§ 371 Date: Jan. 7, 2011

(51) Int. Cl. G06F 3/041; G06F 1/16

(52) U.S. Cl. 345/173; 361/679.27; 361/679.06

(57) ABSTRACT

A tablet computer including a display panel including a display screen that is surrounded by an outer housing that defines a top edge of the display panel, the display panel further including an internal antenna that is positioned within the housing adjacent the top edge, and a base to which the display panel is pivotally connected, the base comprising a metal-free zone adjacent its front edge, which is positioned adjacent the top edge of the display panel when the tablet computer is placed in a tablet mode orientation, wherein the metal-free zone facilitates operation of the antenna.

### BACKGROUND

Tablet computers, also known as “tablet PCs,” are gaining in popularity. Tablet PCs are often similar in form and function to notebook computers. Therefore, many tablet PCs comprise a base and a display panel that pivots relative to the base along a horizontal axis. Unlike conventional notebook computers, however, the display panels of tablet PCs can also be pivoted about a vertical axis, thereby enabling the display panel to be rotated through 180 degrees and folded down on top of the base, such that the tablet PC can be used in similar matter to a notepad. When the tablet PC is used in such a configuration, it may be said to be in “tablet mode.”

It is now common for notebook computers and tablet PCs to incorporate antennas that enable wireless communication. For example, notebook computers often have internal antennas within the display panels. Tablet PCs, on the other hand, typically have external antennas given that metal objects of the base can interfere with signals sent to and from an internal antenna of the display panel when the tablet PC is operated in tablet mode. Such external antennas are often pivotally mounted adjacent the top corners of the display and can be manually extended or retracted by the user.

External antennas have inherent disadvantages. For example, such antennas are easily broken. As a further example, users often do not understand how to correctly use external antennas, or simply forget to extend them when wirelessly communicating.

### BRIEF DESCRIPTION OF THE DRAWINGS

The disclosed tablet computers can be better understood with reference to the following drawings. The components in the drawings are not necessarily to scale.

FIG. 1 is a perspective view of an embodiment of a tablet computer comprising an internal antenna.

FIG. 2 is a partial exploded perspective view of a base of the tablet computer of FIG. 1, illustrating an inner chassis of the base.

FIG. 3 is a further perspective view of the tablet computer of FIG. 1, with the tablet computer shown in tablet mode.

FIG. 4 is a partial side view of the tablet computer of FIG. 3.

### DETAILED DESCRIPTION

As described above, metal within the base of a tablet PC can interfere with an internal antenna provided within the display panel when the tablet PC is used in tablet mode. Although external antennas may not encounter the same interference, there are disadvantages to use of external antennas. As described in the following, the need for an external antenna can be obviated by ensuring that the portion of the base adjacent an internal antenna provided within the display panel is free of metal that can interfere with operation of the antenna.

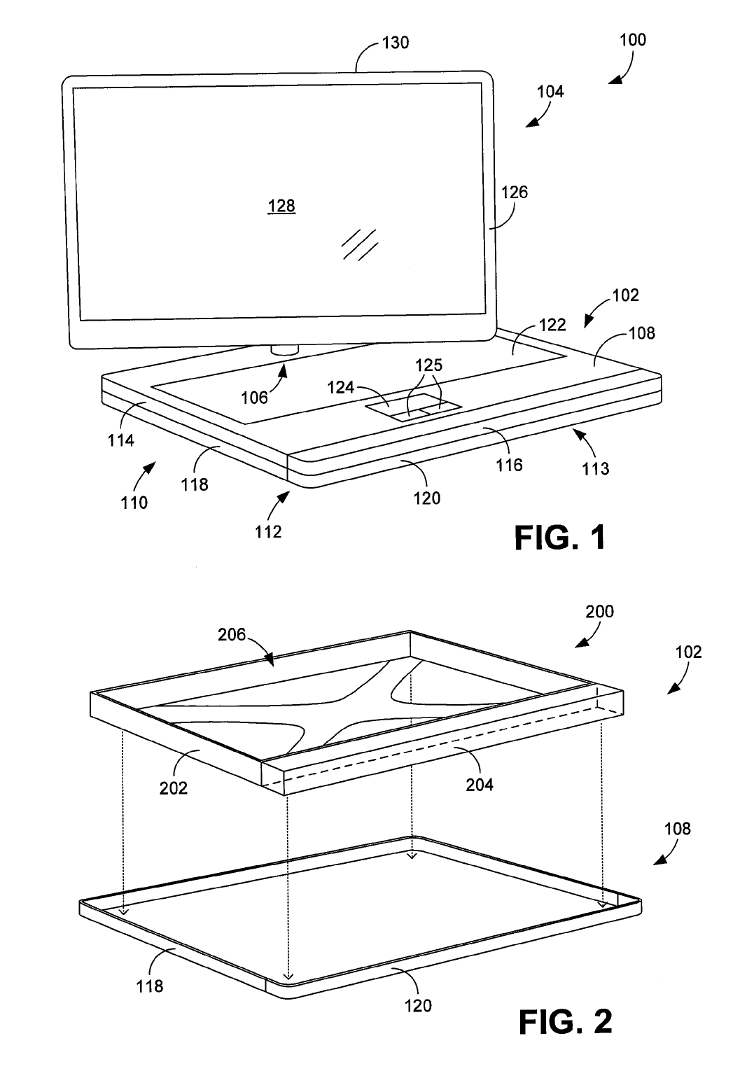

Referring now in more detail to the drawings in which like numerals indicate corresponding parts throughout the views, FIG. 1 illustrates a tablet computer 100, which may also be referred to as a “tablet PC.” The latter term is used throughout the remainder of this disclosure for convenience. It is noted, however, that use of the term “PC” is not intended to limit the scope of the present disclosure to a what is often referred to as an “IBM-compatible” computer.

As indicated in FIG. 1, the tablet PC 100 includes a base 102 and a display panel 104. The display panel 104 is pivotally connected to the base 102 with a multi-axis hinge 106. The base 102 includes an outer housing 108 that surrounds various internal components of the tablet PC 100, such as a processor, memory, hard drive, and the like. The outer housing 108 comprises a main or body portion 110, which forms the majority of the housing, and a front portion 112, which forms the front side or edge 113 of the base 102. The body portion 110 may be, at least in part, constructed of metal for increased rigidity, particularly when the base 102 is relatively thin. The front portion 112 of the housing 108 comprises no metal, however, to avoid interfering with operation of an internal antenna of the tablet PC 100 described below. By way of example, the front portion is exclusive composed of plastic material. In the illustrated embodiment, both the body portion 110 and the front portion 112 comprise an upper portion 114, 116 and a lower portion 118, 120 that are connected together to define an interior space of the base 102. Although a specific configuration has been described for the outer housing 108, it is noted that the outer housing can comprise alternative constructions, as long as at least the front portion or section of the housing is free of metal. With further reference to FIG. 1, the base 102 includes user input devices, including a keyboard 122, a mouse pad 124, and selection buttons 125.

The display panel 104 includes its own outer housing 126. That housing 126 surrounds a display screen 128, which can, for example, comprise a touch-sensitive liquid crystal display (LCD) screen. As described below, the display panel 104 further comprises an internal antenna (FIG. 4) provided within the housing 126 that extends across the panel adjacent a top edge 130 of the panel.

Referring next to FIG. 2, illustrated is the base 102 with the upper portions 114, 116 of the outer housing 108 removed so as to reveal an inner chassis 200 of the base. Like the outer housing 108 of the base 102, the chassis 200 comprises a main or body portion 202 and a front portion 204 that, for example, is mounted to the body portion. In some embodiments, the body portion 202 is constructed of metal. By way of example, the body portion 202 comprises a stamped piece of sheet metal. As indicated in FIG. 2, the body portion 202 defines an inner space 206 in which the various internal components of the tablet PC 100 (e.g., processor, memory, hard drive, motherboard, etc.) can be positioned and secured.

Unlike the body portion 202, the front portion 204 of the chassis 200 comprises no metal or internal components that may comprise metal. In some embodiments, the front portion 204 is exclusively composed of one or more plastic materials and is substantially hollow (i.e., free of any internal components) such that the front portion largely comprises dead space through which wireless signals can pass with relative ease. Optionally, the front portion 204 includes inner non-metal reinforcements (not shown) that provide rigidity and structural integrity.

In alternative embodiments, the base 102 may not comprise the front portion 204, or the front portion (and any reinforcements it comprises) can be integrated into the front portion 112 of the outer housing 108. Irrespective of whether the front portion 204 is or is not provided, the front portion or section of the base 102 comprises no metal that can interfere with wireless communications. Such construction results in a metal-free zone (see FIG. 4) that is formed adjacent the edge 113 of the base 102. In some embodiments, that zone (which is generally coincident with the rectangular volume of the front portion 204 shown in FIG. 2) generally extends from the top of the base to the bottom of the base, from one lateral edge of the base to the opposite lateral edge of the base, and into the base (i.e., from the front edge 113 toward the display panel 104) to a depth of approximately 0.25 to 1 inch, for example approximately 0.5 inches.

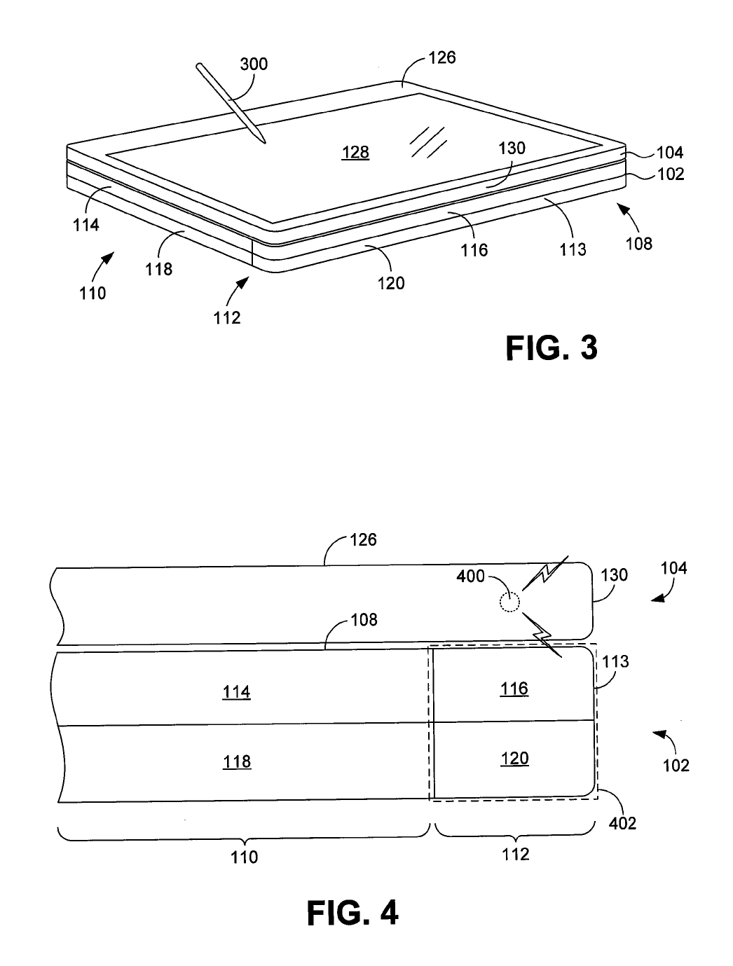

FIG. 3 illustrates the tablet PC 100 as configured for tablet mode operation. As indicated in that figure, the display panel 104 has been, relative to the orientation shown in FIG. 1, rotated and flipped down on top of the base 102 with the display screen 128 facing outward. When the tablet PC 100 is in that orientation, the user can, for example, input information into the PC using the touch-sensitive display screen 128 and a stylus 300 or other input device. As is apparent from FIG. 3, the top edge 130 of the display panel 104 is positioned adjacent (i.e., directly opposite) to the front portion 112 of the outer housing 108 and, therefore, adjacent (i.e., directly opposite) to the metal-free zone of the base 102.

FIG. 4 illustrates a portion of the tablet-PC 100 in side view. In particular, FIG. 4 illustrates the top edge 130 of the display panel 104 and the front edge 113 of the base 102 when the tablet-PC 100 is configured for tablet mode operation, as in FIG. 3. As shown in FIG. 4, the outer housing 126 of the display panel 104 houses an internal antenna 400 that extends transversely (i.e., into the page) within the housing adjacent the top edge 130. Although only one antenna is shown in FIG. 4, the display panel 104 may comprise multiple such antennas. As is apparent in FIG. 4, the antenna 400 is placed in close proximity to a metal-free zone 402 of the base 102, which encompasses the front portion 112 of the outer housing 108. Accordingly, wireless (e.g., radio frequency) signals can be transmitted from and received by the antenna 400 without interference from metal that would otherwise occupy the front section of the base 102. In some embodiments, the antenna is specifically tuned to transmit through the material (e.g., plastic) that forms that section of the base 102.

We claim:

1. A tablet computer comprising:
a display panel including a display screen that is surrounded by an outer housing that defines a top edge of the display panel, the display panel further including an internal antenna that is positioned within the housing adjacent the top edge; and
a base to which the display panel is pivotally connected, the base comprising a metal-free zone adjacent its front edge, which is positioned adjacent the top edge of the display panel when the tablet computer is placed in a tablet mode orientation, wherein the metal-free zone facilitates operation of the antenna.

2. The tablet computer of claim 1, wherein the display screen comprises a touch-sensitive display screen.

3. The tablet computer of claim 1, wherein the base comprises an outer housing having a body portion and a front portion, the front portion of the housing comprising no metal.

4. The tablet computer of claim 3, wherein the body portion of the housing comprises metal.

5. The tablet computer of claim 1, further comprising an inner chassis that is provided within the base, the chassis having a body portion and a front portion, the front portion of the chassis comprising no metal.

6. The tablet computer of claim 5, wherein the body portion of the inner chassis comprises metal.

7. The tablet computer of claim 5, wherein the body portion of the inner chassis defines an inner space in which internal components of the tablet computer are secured and the front portion of the inner chassis comprises no such internal components.

8. The tablet computer of claim 1, further comprising a multi-axis hinge that connects the display panel to the base.

9. The tablet computer of claim 1, wherein the metal-free zone generally extends from a top of the base to a bottom of the base, from a lateral edge of the base to an opposite lateral edge of the base, and a depth into the base from the front edge of the base toward the display panel.

10. The tablet computer of claim 9, wherein the depth to which the metal-free zone extends into the base from the front edge is approximately 0.5 to 1 inch.

11. A tablet computer comprising:
a display panel including a touch-sensitive display screen that is surrounded by an outer housing that defines a top edge of the display panel, the display panel further including an internal antenna provided within the outer housing that extends transversely across the display panel adjacent the top edge; and
a base to which the display panel is pivotally connected, the base comprising an outer housing haying a front portion that comprises no metal, the base further comprising an inner chassis that is provided within the outer housing, the chassis having a front portion that also comprises no metal, wherein there are no metal-containing components position within the front portions of the outer housing or the inner chassis such that an entire front section of the base comprises a metal-free zone that is positioned adjacent the antenna of the display panel when the display panel is folded down onto the base with the display screen facing outward.

12. The tablet computer of claim 11, wherein the body portion of the outer housing comprises metal.

13. The tablet computer of claim 11, wherein the body portion of the inner chassis comprises metal.

14. The tablet computer of claim 11, wherein the metal-free zone generally extends from a top of the base to a bottom of the base, from a lateral edge of the base to an opposite lateral edge of the base, and a depth into the depth to which the base from the front edge of the base toward the display panel.

15. The tablet computer of claim 14, wherein the metal-free zone extends into the base from the front edge approximately 0.5 to 1 inch.
